(19) United States
(12) Patent Application Publication
(10) Pub. No.: US 2007/0266989 A1
(43) Pub. Date: Nov. 22, 2007

(54) Intake accelerator for an engine

(76) Inventor: Chung-Yu Yang, Taipei City (TW)

Correspondence Address: BACON & THOMAS, PLLC, 625 SLATERS LANE, FOURTH FLOOR, ALEXANDRIA, VA, 22314, US

(21) Appl. No.: 11/797,937

(22) Filed: May 9, 2007

(30) Foreign Application Priority Data
May 17, 2006 (TW) 095117430

(51) Int. Cl. F02B 31/00; F02M 29/00

(52) U.S. Cl. 123/306; 123/590

(57) ABSTRACT

An intake accelerator for an engine, the intake accelerator is installed in the front end of a pipe line at an intake of an engine to increase the efficiency of the engine. The main body of the accelerator is provided therein with a plurality of vortex guiding blades extending from a periphery to the center of the wall of a pipe, thereby a vortex passage is formed between every two neighboring ones of the vortex guiding blades; these vortex passages circle in the interior of the main body of the accelerator, so that after air flow enters the main body of the accelerator, it is guided to generate a plurality of vortexes running in the same direction, this can increase the air flow of the vortexes.

### BACKGROUND OF THE INVENTION

1. Field of the Invention

The present invention relates to a vortex generating structure, and especially to an intake accelerator for an engine for vortex generating, the intake accelerator is installed in the front end of a pipe line at an intake of an engine to increase the efficiency of the engine.

2. Description of the Prior Art

An engine is also called generally as an internal combustion engine; its principle of action is to lead fuel and air into a cylinder of the engine to generate therein violent combustion to releasing very much energy to be converted into power for running a machine.

The higher the rotating rate of the engine is, the larger the amount of air led into the cylinder in a unit time can be obtained; for the purpose of getting better intake effect when the engine is running with high rate, manufacturers studied and developed an accelerator to be added in the front end of a pipe line at an intake of the engine to get more sufficient air during running of the engine, with an object of making the air flowing in the front end of the pipe line at the intake of the engine generate a vortex; such vortex can render the air to pass the pipe line with high speed and in a vortex mode when a large amount of air passes through the front end of the pipe line at the intake of the engine, without having the situation of air detaining.

As is shown in FIG. 1 which presents a conventional structure of a kind of accelerator prevailing in the markets, the accelerator is installed in the front end of a pipe line at an intake of an engine; the technical means for assembling is resided in: a round pipe 90 with a larger diameter is provided therein with a central hollow pipe 91 with a smaller diameter, and a plurality of arched blades 92 are provided between the round pipe 90 and the central hollow pipe 91. Therefore, when air flows through the accelerator, the air at the center generates a straight line air flow when it passes through the accelerator, the ambient air is diverted into a plurality of vortical air flows when it passes through the arched blades 92; when the straight line air flow and the multiple vortical air flows leave the accelerator, they are integrated into one vortical air flow. However, such a technical means is subjected to generating partial turbulence by integrating of the straight line air flow and the vortical air flows when they leave the accelerator; thereby the original expected effect of vortex of the accelerator is largely reduced, and even vibrating and noises may be created by this.

In the conventional techniques, there is another accelerator able to integrate and guide a plurality of vortical air flows, as is shown in FIG. 2, such an accelerator is provided structurally in a round pipe 90 with a central guiding post 93, and is provided between the round pipe 90 and the central guiding post 93 with a plurality of arched blades 92, the tailing end of the central guiding post 93 is conical, and the tailing ends of the central guiding post 93 as well as the arched blades 92 are left with end openings 94; thereby when air flow passes the accelerator, it is diverted to flow toward the gaps between every two arched blades 92 to form a plurality of vortical air flows, and when the air flows leave the accelerator, by having the conical shape of the tailing end of the central guiding post 93, the plural vortical air flows are guided to do initial integration.

However, although such a technical means can make smooth of the integration of the plural vortical air flows, the structure of the tailing end of the central guiding post 93 and the end openings 94 are all structures difficult to process in the industry, limitation in use material can be easily encountered, for instance: it is hard to integrally injection form them using plastic, and thereby it is often that metallic material can be needed for producing and assembling the round pipe 90, the arched blades 92 and the central guiding post 93; and further it needs related positioning and connecting processes for assembling, such as the case of U.S. Pat. No. 6,158,412.

### SUMMARY OF THE INVENTION

In view that in the conventional techniques, air flow is diverted into a plurality of vortical air flows and a straight line air flow when it passes through the accelerator, then the air flows are integrated to lower its vortex effect; it is the gist of the present invention to provide an accelerator which is easy for producing and can elevate its vortex effect without further air flow integration.

The accelerator of the present invention is provided in the main body thereof with a plurality of vortex guiding blades extending from the periphery to the center of the wall of a pipe, thereby a vortex passage is formed between every two neighboring ones of the vortex guiding blades; these vortex passages circle in the interior of the main body of the accelerator, so that after air flow enters the main body of the accelerator, it is guided to generate a plurality of vortexes running in the same direction, this can increase flow of the air of the vortexes.

When in practicing, the vortex guiding blades are kept appropriate distances from each other near the central area of the accelerator to form a central passage, and each vortex passage is communicated with the central passage; therefore, when the air flow passes through the accelerator, although the air in the main body of the accelerator is guided by the vortex passages to generate the vortexes, by virtue that each vortex passage is communicated with the central passage, no diverted air flow or diverted air branch will be created, thereby these vortical air flows can have their air flow increased without further air flow integration, thereby the partial turbulence generated by integrating of the straight line air flow and the vortical air flows as in the conventional techniques can be gotten rid of.

Additionally, the main body of the accelerator of the present invention can further be provided with a cut slit which corresponds in position to one of the vortex passages, to thereby make the main body of the accelerator completely broken along this vortex passage, and to thereby make the main body of the accelerator present a slightly reduced outer diameter when it is compressed in favor of using in a pipe line with a slightly smaller inner diameter.

And when in practicing, the vortex guiding blades are mutually connected at an area near the central area of the main body of the accelerator; so that after air flow enters the main body of the accelerator, it is guided to generate a plurality of vortexes running in the same direction, this can increase the air flow of the vortexes without further air flow integration.

Additionally, for the purpose of making the main body of the accelerator able to be used in the front end of a pipe line at an intake with any of various inner diameters of an engine, the main body of the accelerator is provided uniformly around its periphery with a plurality of positioning slits each with a positioning engaging block of a suitable thickness, in order that the main body of the accelerator can be positioned in a pipe line of a slightly larger inner diameter.

Further in order to make the vortical air flows present a situation of having slower flow rate in the outer area and faster flow rate in the inner area of the air flows after they leave the accelerator, the main body of the accelerator is provided on a rear section of its inner wall with a longitudinal linearly knurled area, the linearly knurled area includes many axially extending recessed wall sections on the inner wall of the main body of the accelerator to reduce the rotation rate of the outer area of the vortical air flows.

In comparison with the conventional techniques, the present invention at least has the following effects:
1. It is structurally simple and is easy to be integrally injection formed of plastic.
2. There is no problem of requiring further air flow integration after air flow leaves the accelerator to lower the vortex effect.
3. The outer diameter of the main body of the accelerator can be slightly reduced in favor of using in a pipe line with a slightly smaller inner diameter.

The present invention will be apparent in its technical means after reading the detailed description of the preferred embodiment thereof in reference to the accompanying drawings.

### BRIEF DESCRIPTION OF THE DRAWINGS

FIG. 1 is a perspective view showing a conventional technique;

FIG. 2 is a perspective view showing another conventional technique;

FIG. 3 is a perspective view showing a first embodiment of the present invention;

FIG. 4 is a sectional view of the first embodiment of the present invention;

FIG. 5 is a perspective view showing a vortex guiding blade in a second embodiment of the present invention;

FIG. 6 is a sectional view of the second embodiment of the present invention;

FIG. 7 is a sectional view of a third embodiment of the present invention;

FIG. 8 is a perspective view of a fourth embodiment of the present invention;

FIG. 9 is a perspective view of a fifth embodiment of the present invention;

FIG. 10 is a schematic sectional view showing actions of the fifth embodiment of the present invention;

FIG. 11 is a perspective view showing a sixth embodiment of the present invention;

FIG. 12 is a sectional view of the sixth embodiment of the present invention;

FIG. 13 is a perspective view showing a seventh embodiment of the present invention;

FIG. 14 is a sectional view of the seventh embodiment of the present invention;

FIG. 15 is a perspective view showing an eighth embodiment of the present invention.

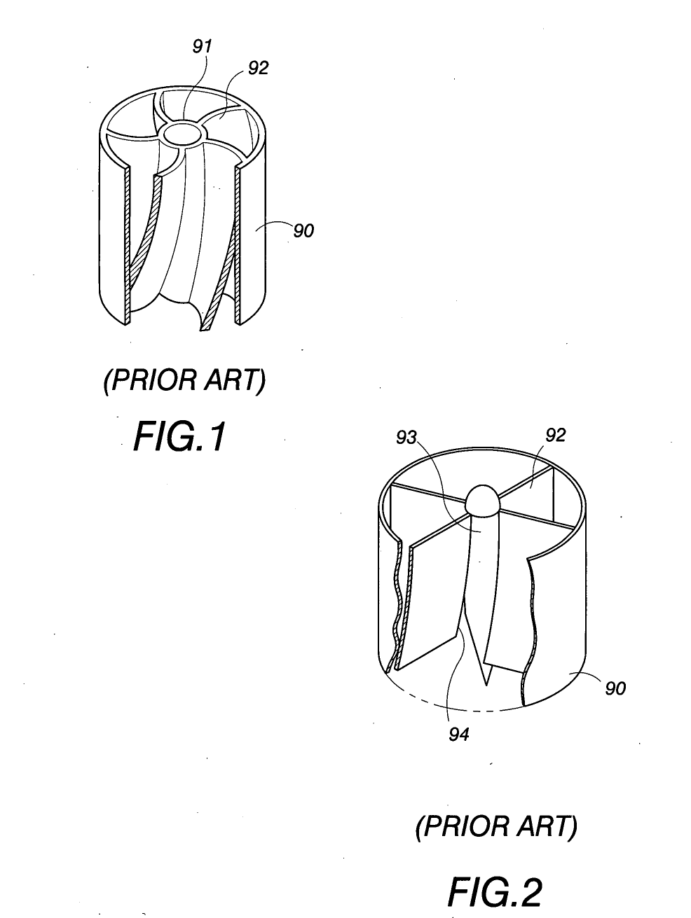

### DETAILED DESCRIPTION OF THE PREFERRED EMBODIMENT

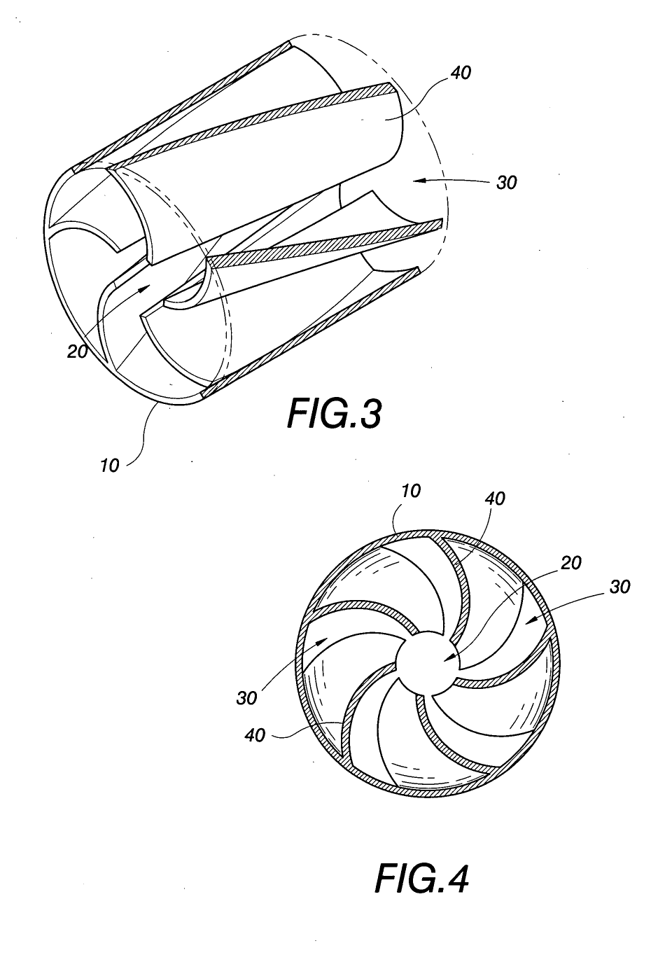

Referring to the first embodiment of the present invention shown in FIGS. 3, 4, wherein the main body 10 of an accelerator is in the shape of a cylinder, the main body 10 of the accelerator is provided with a central passage 20 and a plurality of vortex passages 30.

The central passage 20 is extended axially through the center of the main body 10 of the accelerator; the vortex passages 30 circle in the interior of the main body 10 of the accelerator and are communicated with the central passage 20. As is depicted in the drawings, the central passage 20 and the vortex passages 30 are formed from a plurality of vortex guiding blades 40 extending from the periphery of the wall of a pipe to the center thereof; wherein the vortex guiding blades 40 are kept appropriate distances from each other near the central area of the main body 10 of the accelerator to form the central passage 20; and a vortex passage 30 is formed between every two neighboring ones of the vortex guiding blades 40; these vortex passages are all communicated with the central passage 20 all the way along their lengths.

So that when air flow passes through the accelerator, although the ambient air forms vortex and flows by guiding of the vortex passages 30, but no diverted air flow or diverted air branch will be created, thereby when air flow passes through the accelerator to generate a plurality of vortexes running in the same direction, acceleration of the vortexes of the air flow passing through the accelerator can be effectively developed without further air flow integration.

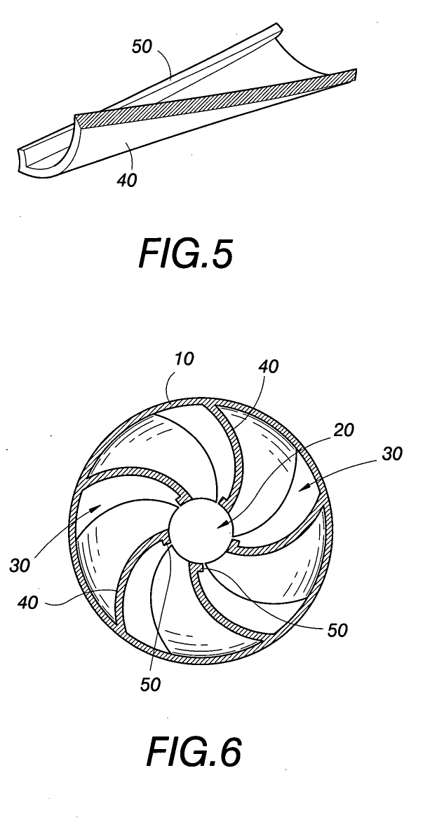

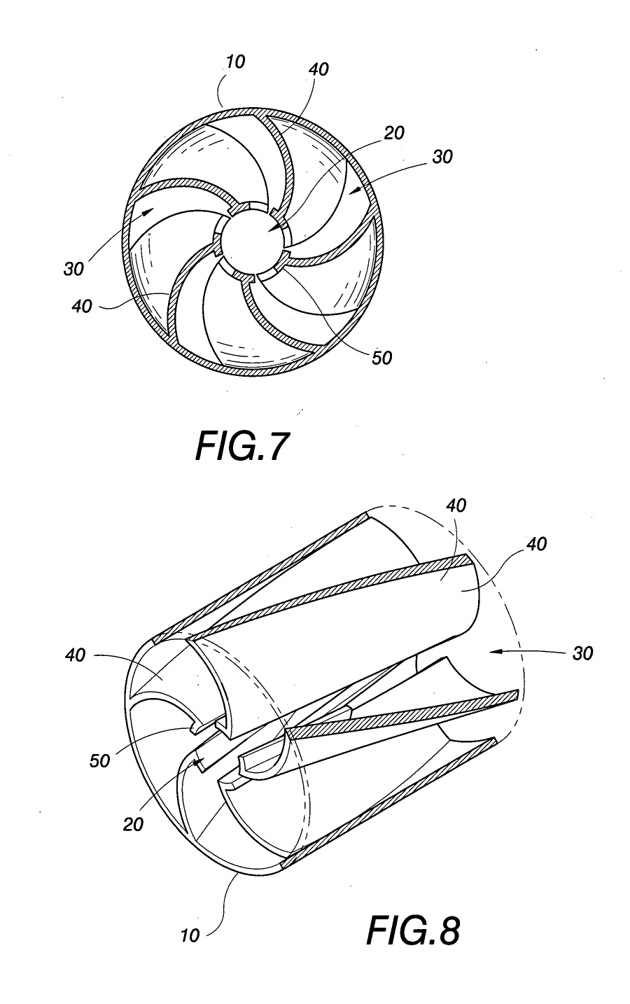

Referring to FIGS. 5, 6, a relieved strip 50 can be provided for each vortex guiding blade 40 at the side neighboring with the central passage 20 to increase the effect of vortex. When in practicing, in addition to that shown in FIG. 6—each relieved strip 50 being relieved out of one side of a vortex guiding blade 40 to form an “L” shape sectional structure, the relieved strips 50 can also be in the mode as shown in FIG. 7, wherein the relieved strips 50 each is relieved out of both sides of a vortex guiding blade 40 to form a “T” shape sectional structure. Moreover, in addition to being along all the length of a vortex guiding blade 40, the relieved strips 50 each can be provided on the front end of a vortex guiding blade 40 as is shown in FIG. 8.

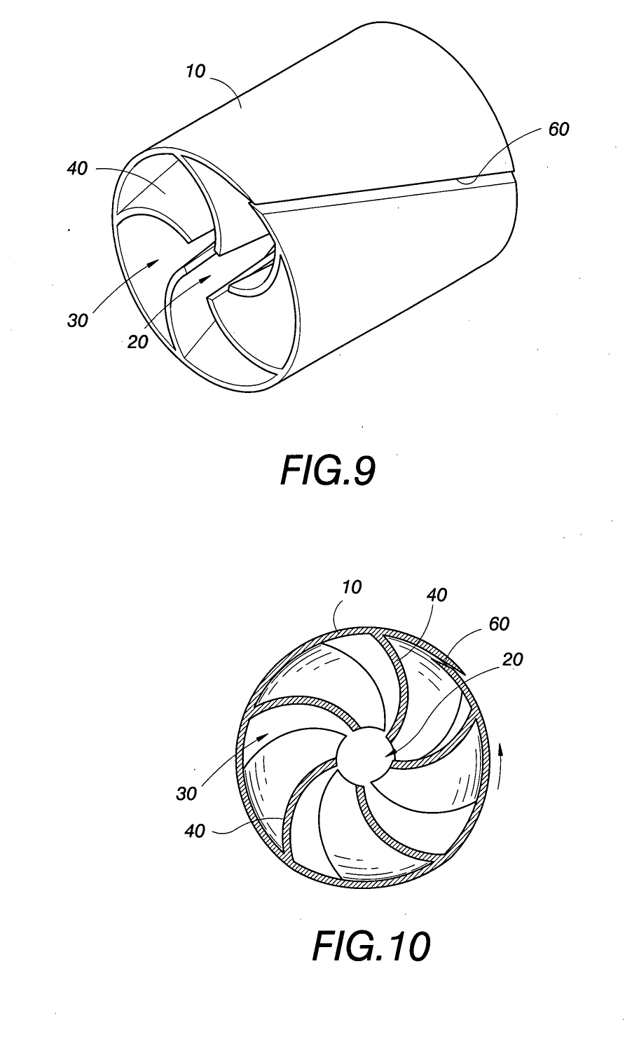

In order to make practicing of the accelerator able to change its outer diameter in pursuance of its environment of installing, as is shown in FIG. 9, the main body 10 of the accelerator is provided with a cut slit 60 which corresponds in position to one of the vortex passages 30, to thereby make the main body 10 of the accelerator completely broken along this vortex passage 30.

As is shown in FIG. 10, by the fact that the cut slit 60 makes vortex passage 30, when the main body 10 of the accelerator is compressed, an effect that its outer diameter is slightly reduced presents, hence the accelerator can be used in a pipe line with a slightly smaller inner diameter.

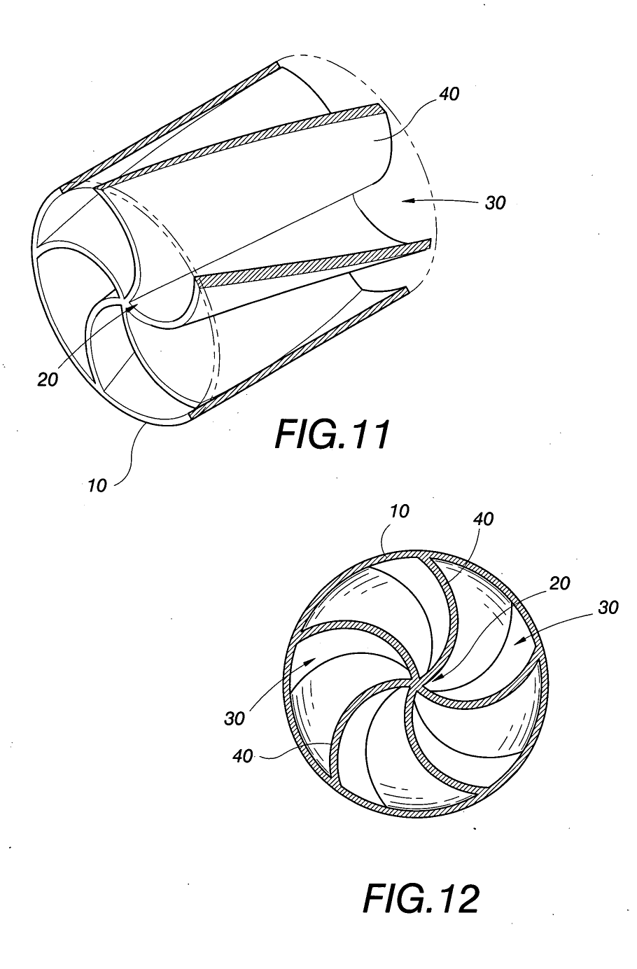

Please refer to FIGS. 11 and 12, when in practicing, the vortex guiding blades 40 in the main body 10 of the accelerator extending from the periphery of the wall of the pipe to the center thereof can be mutually connected at the area near the central area of the main body 10 of the accelerator, so that after air flow enters the main body 10 of the accelerator, the air flow is guided by the vortex passages 30 to generate a plurality of vortexes running in the same direction, this can increase the air flow of the vortexes without further air flow integration. Thereby partial turbulence generated by integrating of the straight line air flow and the vortical air flows as in the conventional techniques can be gotten rid of.

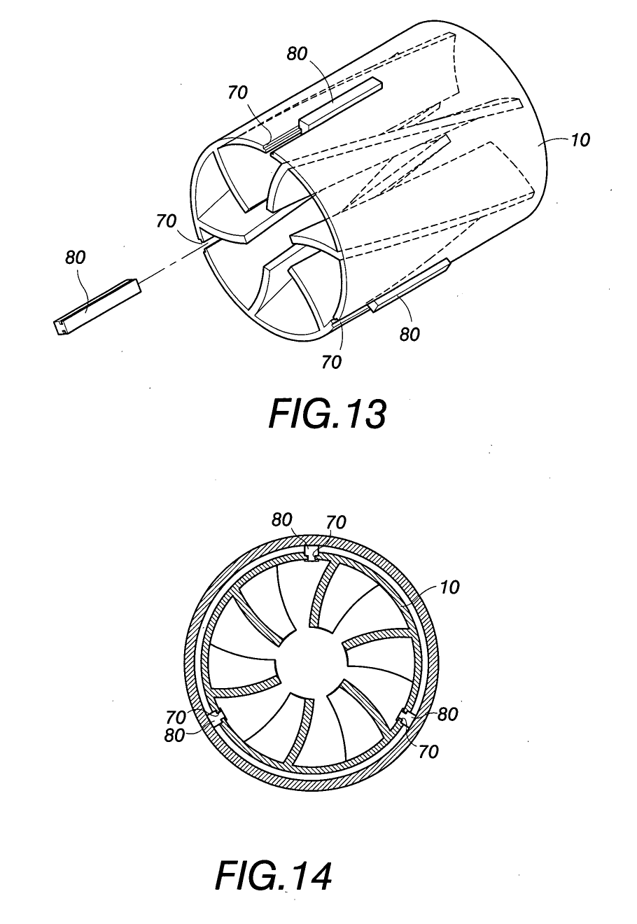

Please refer to FIGS. 13 and 14, in order to make the main body 10 of the accelerator able to be used in the front end of a pipe line at an intake with any of various inner diameters of an engine, the main body 10 of the accelerator is provided uniformly around its periphery with a plurality of positioning slits 70 each with a positioning engaging block 80 of a suitable thickness, in order that the main body 10 of the accelerator can be positioned in a pipe line of a slightly larger inner diameter. In this embodiment, the sectional area of each positioning engaging block 80 is in the shape of “H”.

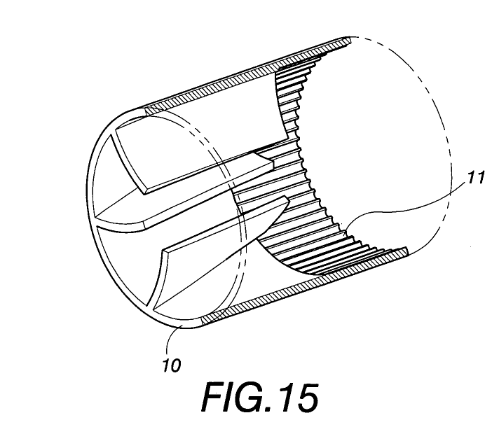

Please refer to FIG. 15, in order to make the vortical air flows present a situation of having slower flow rate in the outer area and faster flow rate in the inner area of the air flows after they leave the accelerator, the main body 10 of the accelerator is provided on a rear section of its inner wall with a longitudinal linearly knurled are all, the linearly knurled area 11 includes many axially extending recessed wall sections of the main body 10 of the accelerator to reduce the rotation rate of the outer area of the vortical air flows.

The embodiment given is only for illustrating the present invention, it will be apparent to those skilled in this art that various equivalent modifications or changes without departing from the spirit of this invention shall also fall within the scope of the appended claims.

1. An intake accelerator for an engine comprising a main body, said intake accelerator is characterized in that:
said main body is provided with a plurality of vortex guiding blades extending from a periphery to a center of a wall of a pipe, said vortex guiding blades are kept appropriate distances from each other near a central area of said accelerator to form a central passage, and a vortex passage is formed between every two neighboring ones of said vortex guiding blades; said vortex passages circle in said main body of said accelerator, and are communicated with said central passage.

2. The intake accelerator for an engine as in claim 1, wherein said accelerator is in a shape of a cylinder.

3. The intake accelerator for an engine as in claim 1, wherein a relieved strip is provided for each of said vortex guiding blades at a side neighboring with said central passage.

4. The intake accelerator for an engine as in claim 3, wherein said relieved strips are relieved each out of one side of a corresponding one of said vortex guiding blades to form an “L” shape sectional structure.

5. The intake accelerator for an engine as in claim 3, wherein said relieved strips are relieved each out of both sides of a corresponding one of said vortex guiding blades to form a “T” shape sectional structure.

6. The intake accelerator for an engine as in claim 3, wherein said relieved strips each is provided on a front end of a corresponding one of said vortex guiding blades.

7. The intake accelerator for an engine as in claim 1, wherein said main body of said accelerator further is provided with a cut slit which corresponds in position to one of said vortex passages to thereby make said main body of said accelerator completely broken along said one vortex passage.

8. An intake accelerator for an engine comprising a main body, said intake accelerator is characterized in that:
said main body is provided with a plurality of vortex guiding blades extending from a periphery to a center of a wall of a pipe, said vortex guiding blades are mutually connected near a central area of said accelerator, and a vortex passage is formed between every two neighboring ones of said vortex guiding blades; said vortex passages circle in said main body of said accelerator.

9. The intake accelerator for an engine as in claim 8, wherein said accelerator is in a shape of a cylinder.

10. The intake accelerator for an engine as in claim 8, wherein said main body of said accelerator is provided uniformly around its periphery with a plurality of positioning slits each with a positioning engaging block of a predetermined thickness, in order that said main body of said accelerator is positioned in a pipe line with an inner diameter slightly larger that an outer diameter of said main body.

11. The intake accelerator for an engine as in claim 8, wherein said main body of said accelerator is provided on a rear section of an inner wall thereof with a longitudinal linearly knurled area, said linearly knurled area includes many axially extending recessed wall sections on said inner wall of said main body of said accelerator.
